(19) United States
(12) Patent Application Publication
(10) Pub. No.: US 2026/0138103 A1
(43) Pub. Date: May 21, 2026

(54) APPARATUS FOR PASSIVE MIXING OF MULTIPHASE FLOW THROUGH SPLITTING

(71) Applicant: SRAVATHI ADVANCE PROCESS TECHNOLOGIES PRIVATE LIMITED, Bengaluru (IN)

(72) Inventors: Chungikar Abbas SOHEL, Bangalore (IN); Sreeramagiri Venkata Shanmukha SOURI, Bangalore (IN); Sreeramagiri SIVAKUMAR, Bangalore (IN); Anapat SAMIR, Bangalore (IN)

(21) Appl. No.: 19/121,819

(22) PCT Filed: Oct. 21, 2023
(86) PCT No.: PCT/IB2023/060646

§ 371 Date: Apr. 17, 2025

(30) Foreign Application Priority Data
Oct. 23, 2022 (IN) 202241060634

(51) Int. Cl. B01F 25/431; B01F 23/21; B01F 23/232; B01F 23/45; B01F 25/432; B01F 101/00

(52) U.S. Cl. CPC B01F 25/4312; B01F 23/21; B01F 23/232; B01F 23/45; B01F 25/432; B01F 2101/2204

(57) ABSTRACT

Apparatus for passive mixing of a multi-phase (ic) flow or hydrodynamic performance that is housing a conduit/tube, which is a channel extending internally from the fluid inlet to the outlet ports, comprising axially stacked plurality of static mixers possessing structural elements or mixing elements (possessing structural elements on their inner walls), that are responsible for continuous splitting, and combining of the flow through the conduit, bringing about enhanced mixing of contents of the flow, mass-transfer, and heat transfer. The structural elements bring about enhanced mixing of multi-phasic systems passing through the conduit such as liquid-liquid, liquid-gas-liquid, and systems comprising immiscible and viscous liquids. The mixing elements or structural elements are responsible for splitting of flow into sections of multiple streams, followed by forced recombination of the multiple streams which is responsible for the equitable dispersion of individual components of the multiphasic flow, thereby enhancing the mixing of the flow.

### RELATED APPLICATIONS

This invention claims the benefit of priority to the Indian provisional application titled “Application for passive mixing of Multiphase flow through splitting” with the application No. 202241060634 (TEMP/E1/70028/2022-CHE) filed on 23-10-2022 and it is hereby incorporated in its entirety for reference.

### FIELD OF THE INVENTION

The instant invention relates to apparatus used for intensifying mixing efficiency and more particularly apparatus comprising stacked plurality of static mixers in a conduit present in a housing, for enhancing multiphase fluid mixing by way of splitting the multiphase flow by the structural elements possessed by the static mixers.

### BACKGROUND OF THE INVENTION

Static mixers find extensive application in a variety of process industries worldwide, since they offer higher rates of mixing efficiency, reliability and economy. Static mixers with their high mixing efficiency and very low head loss find wider utility in process industries such as food and pharmaceutical industries, wastewater treatment plants and oil and natural gas industries. Static-mixers are environmental-friendly. As there are no moving parts in static mixers, the mixing action is brought about by way of the geometry of the static mixer and/or by the introduction of structural elements such as vanes, arcs, protrusions, helices, structural elements having cut-slots/holes, bar like structures, that can split, twist, expand and constrict the fluid that is passing through or passing by them. Multiphasic systems comprising liquid-liquid, liquid-liquid-gas, immiscible fluids do essentially need a thorough mixing of the different phases for yielding products with high purity.

Static mixers are a definite choice for obtaining intensified mixing of the constituents of the fluids in a multiphasic system. Many reports are available regarding the usage of static mixers with structural elements for splitting the flow in multiphasic systems for obtaining a thorough mixing.

Patent CN114797642A disclosed a pressure adjustable static mixer, comprising outlets at two ends of the outer sleeve respectively used for feeding and discharging, wherein a fixing frame is fixed on the inner wall of the outer sleeve with at least one sub-mixer along the length direction of the outer sleeve detachably mounted on the fixing frame wherein, the sub-mixer includes a plurality of mixing units, and the mixing unit is of a plate-shaped structure comprising a plurality of grooves and bulge. The plurality of material passing ports are formed in the positions close to the grooves of the mixing units wherein the grooves of each mixing unit correspond to the bulges of the adjacent mixing units, and the bulges correspond to the grooves of the adjacent mixing units.

Patent WO2021108245A3 disclosed a static mixer and a system containing static mixer for manufacturing by additive method wherein the static mixer also comprises a mixing element (42) disposed within the mixing cavity (36). The mixing element (42) is configured to be free from an impingement surface oriented substantially perpendicular to a main direction of fluid flow through the internal mixing cavity (36). The mixing element (42) comprises an elongated mixing blade that is oriented longitudinally within the mixing cavity (36) and comprises a nose axially oriented toward the inlet (38).

Patent US20040240315 disclosed a draft tube mixing system or reactor wherein the draft tube contains slots, perforations, or cut-out sections that allow cross flow of fluid through the draft tube wall and the perforations or slots were of different shapes, but rectangles and circles were preferred for ease of manufacture.

U.S. Pat. No. 4,201,482A disclosed perforated mixing elements for static and dynamic mixers wherein a mixing insert of solid material into which intersecting channels are drilled particularly suitable for use as a static mixer for highly viscous liquids is described. The insert provides a high quality of mixing while withstanding pressure differences of more than 107 Pa along the mixer. If the insert is rotated, static and dynamic mixing properties are superimposed on each other in the mixer.

Patent US20080232190 disclosed A mixing element (1) for inversion and mixing of flowing materials in a flow channel, comprising an axially symmetrical base body (1 a) having a longitudinal axis (A), wherein the base body (1 a) has a surface (1 k) facing outwardly with respect to the longitudinal axis (A) and respective end faces (1 m) at each end of the longitudinal axis (A), further comprising a plurality of guiding elements (1 b) that are coupled to the base body (1 a) at the surface (1 k) via a foot area (1 l), wherein the guiding elements (1 b) extend obliquely to the longitudinal axis (A) so that each guiding element (1 b) has an inwardly facing guiding surface (1 d) with respect to the longitudinal axis (A) and an outwardly facing guiding surface (1 c) with respect to the longitudinal axis (A) and wherein a plurality of guiding elements (1 b) are sequentially arranged in circumferential direction (A 1) of the longitudinal axis (A).

JP6085428B2 disclosed a plastic static mixer including an installation body for installation in a tubular mixer housing. The installation body has a longitudinal axis that is aligned with the direction of the fluid flowing into the installation body so that it can extend into the mixing space. The mixing space has a cross-sectional flow region in a plane perpendicular to this longitudinal axis, which corresponds to the cross-sectional flow region of the essentially tubular mixer housing. The installation body includes a wall element for separating and/or deflecting the fluid flow away from the longitudinal axis.

AkramGhanem et al reviewed “Static mixers: Mechanisms, applications, and characterization methods”. Their review throws light on the current industrial applications from a process intensification perspective, focusing on mixing and mass transfer performance (Chemical Engineering Research and Design, Volume 92, Issue 2, February 2014, Pages 205-228).

EP 0071454A1 disclosed a static mixer comprising a conduit for transporting flowable material, and a plurality of stationary mixer elements which so deflect the flow of material that a thorough mixing is effected. Each mixer element comprised seven plate members: a diamond-shaped plate (34); two triangular plates (48,50), co-planar and perpendicular to the diamond-shaped plate, the base of one triangular plate providing a leading edge to divide material flow into the conduit into two separate flows; and four deflector plates (66,68,70,72), which join the diamond-shaped and triangular plates and conform to the contours of inner walls of the conduit to provide two separate flow paths.

U.S. Pat. No. 4,025,996 disclosed self-supporting structural elements formed of an integral sheet characterized by alternating elevations and depressions which sinusoidally vary about a flat or curved surface of neutrality, the element being suitable for use as a core in composite shell structures.

Patent US20070263486 disclosed a mixing element constructed for installation in a fluid-conducting conduit having an inlet opening of a first cross-section and an outlet opening of a larger second cross-section which is arranged in a plane disposed substantially normal to the main direction of flow. The mixing element has a cross-sectional design which increases substantially continuously from the first cross-section to the second cross-section. Flow-dividing layers are arranged in the mixing element such that a precise fitting of the mixing element into the substantially continuously expanding fluid-conducting means is made possible.

Olumide Adewole et al discussed performance characterization of a Kenics static mixer using slotted elements. They found that the Kenics static mixer performance could be optimized with the use of slotted mixer elements as it was observed that the slot width size and a varying number of slots on the mixer elements had an impact on its performance (IOP Conference Series Materials Science and Engineering 1107 (012119): 1-8).

Though the prior art cited discloses various mixing elements for improving the mixing efficiency of a static mixer, there is still a lot of scope and necessity for coming out with an apparatus that operates in a splitting and recombining mode for intensifying the mixing of a multiphasic flow by way of the incorporation of suitable structural elements on the inner walls of the individual static mixers that can be stacked in a conduit or pipe. Hence the instant invention of “Apparatus for Passive Mixing of Multiphase Flow through Splitting” is taken up. The exemplary embodiments of the invention are disclosed in the summary of the invention and the best method of obtaining the invention are disclosed hereunder.

The exemplary aspects of various embodiments of the invention are disclosed in the summary of the invention and all the essential aspects relating to the various embodiments of the invention are described in a detailed manner in the following paragraphs with specific references towards the corresponding figures as given hereunder. All the prior art references are incorporated hereby in their entirety and for reference-sake and in no way taking away the novelty of the instant invention. The various aspects of the invention disclosed herein are definitely an improvement over the existing prior art and further stress upon the inventorship, novelty and applicability of the instant invention in the field of intensification of passive mixing ability of static mixers that operate in split and combine mode.

### BRIEF DESCRIPTION OF THE DRAWINGS

Various aspects of the embodiments are discussed below with reference to the accompanying figures, which are not necessarily drawn to scale. The figures are included to provide an illustration and a further understanding of the various aspects and embodiments, and are incorporated in, and constitute a part of this specification, but are not intended as a definition of the limits of any particular embodiment. The figures, together with the remainder of the specification, serve only to explain principles and operations of the described and claimed aspects and embodiments, but are not to be construed as limiting embodiments.

In the figures, each identical or nearly identical component that is illustrated in various figures is represented by a like numeral. For purposes of clarity, not every component may be labelled in every figure. A brief description of the figures containing exemplary aspects of the invention are given hereunder.

FIG. 1 depicts the 3D image of the apparatus for passive mixing of multiphase flow through splitting means for intensifying the multi-phasic flow.

FIG. 2 depicts the cross-sectional view of the apparatus comprising the assembly of stacked static mixers wherein each individual static mixer possesses sinusoidal-wavy bar structural elements, and their arrangement in a conduit, wherein the splitting action is realized by way of the structural elements, showing the alternating splitting and combining zones. The 3D image of the Splitting pattern for static mixing of fluids is depicted herein. Alternating splitting and combining pattern is repeated through the length of the process side.

FIG. 3 depicts the cross-sectional view of the apparatus comprising the assembly of stacked static mixers wherein each individual static mixer possesses shuttle-cock structural elements, and their arrangement in a conduit, wherein the splitting action is realized by way of the structural elements, showing the alternating splitting and combining zones. The 3D image of the Splitting pattern for static mixing of fluids is depicted herein. Alternating splitting and combining pattern is repeated through the length of the process side.

FIG. 4 depicts the cross-sectional view of the apparatus comprising the assembly of stacked static mixers wherein each individual static mixer possesses slotted-hyperbolic-paraboloid structural elements, and their arrangement in a conduit, wherein the splitting action is realized by way of the structural elements, showing the alternating splitting and combining zones. The 3D image of the Splitting pattern for static mixing of fluids is depicted herein. Alternating splitting and combining pattern is repeated through the length of the process side.

FIG. 5 depicts the cross-sectional view of the apparatus comprising the assembly of stacked static mixers wherein each individual static mixer possesses slotted-paraboloid structural elements, and their arrangement in a conduit, wherein the splitting action is realized by way of the structural elements, showing the alternating splitting and combining zones. The 3D image of the Splitting pattern for static mixing of fluids is depicted herein. Alternating splitting and combining pattern is repeated through the length of the process side.

FIG. 6: Axial View of the embodiment of the invention pertaining to sinusoidal-wavy bar mixer as disclosed in FIG. 2 for the first time.

FIG. 7: Cut Section View of the embodiment of the invention pertaining to sinusoidal-wavy bar mixer as disclosed in FIG. 2 for the first time.

FIG. 8: Orthogonal Projected View of the embodiment of the invention pertaining to sinusoidal-wavy bar mixer as disclosed in FIG. 2 for the first time.

FIG. 9: Axial View of the embodiment of the invention pertaining to shuttle-cock mixer as disclosed in FIG. 3 for the first time as the flow enters mixer.

FIG. 10: Front Cut Section of the embodiment of the invention pertaining to shuttle-cock mixer as disclosed in FIG. 3 for the first time.

FIG. 11: Axial view of the embodiment of the invention comprising slotted-hyperbolic-paraboloid structural element as disclosed in FIG. 4 for the first time as the fluid enters the mixer.

FIG. 12: Front view of the embodiment of the invention comprising slotted-hyperbolic-paraboloid structural element as disclosed in FIG. 4 for the first time.

FIG. 13: Side view of the embodiment of the invention comprising slotted-hyperbolic paraboloid structural element as disclosed in FIG. 4 for the first time.

FIG. 14: Categorized surfaces as seen in FIG. 15 when applied to the actual static mixer surface pertaining to the embodiment of the invention comprising slotted-hyperbolic-paraboloid structural element as disclosed in FIG. 4 for the first time.

FIG. 15: Generalized view of embodiment of the invention comprising slotted-Hyperbolic Paraboloid structural element as disclosed in FIG. 4 for the first time, that splits into 4 distinct surfaces.

FIG. 16: Axial view of the embodiment of the invention comprising slotted-paraboloid structural element as disclosed in FIG. 5 for the first time, as the fluid enters the mixer.

FIG. 17: View of cut section of the embodiment of the invention comprising slotted-paraboloid structural element as disclosed in FIG. 5 for the first time.

FIG. 18: View of the embodiment of the invention comprising slotted-paraboloid structural element, as disclosed in FIG. 5 for the first time, without outer pipe.

The various exemplary aspects of the different embodiments of the instant invention as briefly described in the figures section are incorporated and are described in detail in the following paragraphs with references drawn towards corresponding figures and exemplary aspects of the instant invention.

### OBJECTIVES OF THE INVENTION

1. To come out with an apparatus comprising stacked plurality of static mixers for the intensification of passive mixing of a multiphasic flow, by way of introducing structural elements or mixing elements on the inner walls of the static mixer that can enhance the passive mixing, of a multiphasic flow by splitting the flow into various streams and recombining them, ensuring a thorough mixing of the multiphasic flow.
2. To come out with an apparatus and a method for the intensification of passive mixing of a multiphasic flow by way of introducing structural elements on the inner walls of the individual static mixers wherein the structural elements split and combine the multiphasic flow passively in such a way that the multiphasic flow experiences alternate splitting and combining in a conduit all along from the inlet port to the outlet port in a housing.
3. To come out with an apparatus for the intensification of passive mixing of multi-phasic systems such as liquid-liquid, liquid-liquid-gas, immiscible solvent systems etc to achieve higher yields, maximum purity of the final product by way of introduction of structural elements in individual static mixers that can be stacked in a conduit or tube responsible for splitting and combining of the multiphasic flow.

### SUMMARY OF THE INVENTION

The exemplary embodiment of the invention discloses an apparatus for passive mixing of a multi-phase flow or hydrodynamic performance by way of splitting and combining the multiphasic flow, that is housing a conduit/tube, which is a channel extending internally from the fluid inlet to the outlet ports, comprising stacked plurality of static mixers possessing structural elements or mixing elements on the inner walls of the individual static mixers that are responsible for alternate splitting and combining of flow through the conduit, bringing about a cumulative splitting and combining effect on the flow. The cumulative splitting and combining effect results in enhanced mixing of the multi-phasic flow. The conduit comprises of a plurality of axially stacked static mixers across the length of the conduit that can allow the fluid to pass through them continuously experiencing splitting and combining effect resulting in improved mixing, mass-transfer, and heat transfer.

One embodiment of the invention discloses stacked plurality of monolith static mixers possessing structural elements, in channel or conduit in a housing for the intensification of mixing in a multiphase flow in split and combine mode of operating for better mass-transfer, heat-transfer, better yield and purity of the end product resulting in an improved performance.

An exemplary embodiment of the invention discloses a stacked plurality of static mixers in a conduit wherein individual static-mixer possesses sinusoidal-wavy bars as the structural elements, that split the flow for intensification of mixing of multiphase flow wherein the wavy bars direct the fluid after splitting, to thoroughly combine with the individual split streams across the length of the conduit thereby resulting in a thorough mixing of the multiphase flow.

Yet another important embodiment of the invention discloses a stacked plurality of monolith static mixers in a conduit for mixing multiphase flow wherein individual static-mixer possesses shuttle-cock type structural elements that force the fluid to split into individual streams radially along the edges of the structural element and mix thoroughly on passing through the structural element.

One more embodiment of the invention discloses a stacked plurality of monolith static mixers in a conduit for mixing multiphase flow wherein each individual static-mixer possesses slotted-hyperbolic-paraboloid structural elements that split the flow region wherein each opening splits the fluid into individual streams and further causes them to experience mixing action along the surfaces of the individual slots and in turn allow them to combine thoroughly on passing through the slotted-hyperbolic-paraboloid structural elements. The slotted structures are responsible for the generation of multiple fluid regions having different velocities, and in turn are responsible for better mixing.

Yet another exemplary aspect of the invention discloses a stacked plurality of static mixers in a conduit for mixing multiphase flow, wherein individual static mixer consists of slotted-paraboloid structural elements that split the flow into various streams and then proceed to combine them which cause the flow to get thoroughly mixed and jet out of the exit of the mixer.

One important aspect of the invention discloses stacking of plurality of the static-mixers possessing structural elements on the inner walls of the individual static mixers that are responsible for the splitting of the multiphasic flow in a conduit in a housing.

One more aspect of the invention discloses the individual static mixer possessing structural elements responsible for splitting the multiphasic flow in a conduit according to any of the embodiments in the form of an insert for intensification of mixing of multiphase flow.

The various embodiments of the instant invention are described in detail with the help of the accompanying drawings, drawing inferences to the specific aspects of the individual embodiments of the invention in the following sections. The various embodiments of the instant invention of “Apparatus for passive-mixing of multiphase flow through splitting” are described in detail drawing reference to the accompanying figures in the following paragraphs. The various embodiments of the invention clearly stress upon the novelty, inventorship and utility aspects of the instant invention compared to the prior art reported hitherto. A person with ordinary skill can easily understand and perform the invention easily. The different aspects of the instant invention as disclosed herein are only illustrative in nature and various other embodiments and working of the invention are possible within the scope of the invention without deviating from the essence of the invention.

### DETAILED DESCRIPTION OF THE INVENTION

The examples of the apparatus discussed herein are not limited in application to the details of construction and the arrangement of components set forth in the following description or illustrated in the accompanying drawings. It will be understood by one of skill in the art that the apparatus is capable of implementation in other embodiments and of being practiced or carried out in various ways. Examples of specific embodiments are provided herein for illustrative purposes only and are not intended to be limiting. Also, the phraseology and terminology used herein is for the purpose of description and should not be regarded as limiting.

Any references to examples, embodiments, components, elements or acts of the apparatus herein referred to in the singular may also embrace embodiments including a plurality, and any references in plural to any embodiment, component, element, or act herein may also embrace embodiments including only a singularity (or unitary structure). References in the singular or plural form are not intended to limit the presently disclosed apparatus, its components, acts, or elements.

The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. The various embodiments of invention are described in detail herein and the various aspects of the invention are disclosed below.

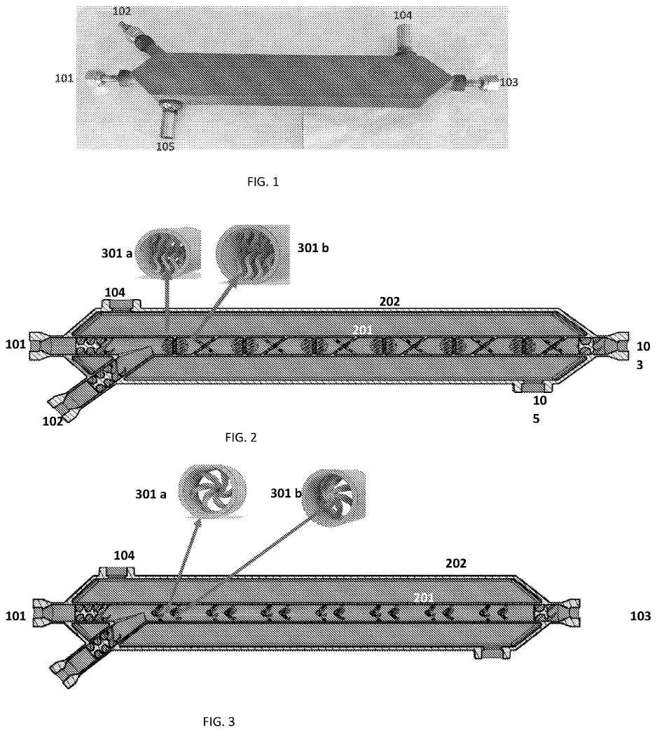

Drawing reference to FIG. 1, which clearly depicts the overall 3D image of the apparatus that is being used for intensifying the mixing in a multi-phasic flow that houses a conduit comprising stacked plurality of static mixers possessing structural elements that are responsible for alternate splitting and combining of flow through the conduit, bringing about the cumulative mixing effect on the flow. The cumulative mixing effect results in the enhanced mixing of the multi-phasic flow. FIG. 1 gives the overall picture of the apparatus housing a conduit/tube, the channel extending internally from the fluid inlet to the outlet ports comprising stacked plurality of static mixers. Here 101 & 102 indicate the process fluid(s) inlet ports, 103 indicates process fluid outlet port. 104 and 105 indicate utility fluid inlet and outlet ports respectively. The conduit comprises of a plurality of stacked static mixers across the length of the conduit that can allow the fluid to pass through them continuously experiencing splitting and combining as is depicted in FIGS. 2-5.

### Description of the Embodiment of the Invention Pertaining to the Apparatus Comprising Static Mixers Possessing Sinusoidal-Wavy Bar Structural Elements as Depicted in FIG. 2 for the First Time

Drawing reference to FIG. 2, the specific embodiment shows the cross-sectional view of the apparatus comprising the stacked individual static mixers possessing sinusoidal-wavy bars as the structural elements wherein the assembly of stacked individual mixers and their arrangement in a conduit is depicted. Here the splitting action is realized by way of the sinusoidal wavy bars that form the structural elements, showing the alternating splitting and combining zones. The dimensions of the conduit on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 200 mm; Inlet nozzle shape is circular in cross-section. On the utility side, the parameters are: thickness is 2 mm; width is 38 mm; Inlet and outlet nozzle diameter is 10 mm; shape is rectangular; The 3D image of the Splitting and combining pattern for static mixing of fluids is clearly depicted herein. The splitting and combining pattern is repeated throughout the length of the process side. Here 201 represents the Metal Wall of the inside tube containing static mixers and the flow volume for process fluid, whereas 202 is the outer casing of the wall. 301 a & b represent the blow-up images of the flow path through the static mixer possessing sinusoidal wavy bars that form the structural elements. The unshaded area indicates the path for fluid flow. The specific embodiment of the invention as depicted in FIG. 2 is further described in detail drawing reference to FIGS. 6-8 that illustrate the specific aspects of the embodiment of the invention as illustrated for the first time in FIG. 2 in the following paragraphs.

### Description of the Mixer

A monolithic static mixer comprising multiple wavy bar elements crisscrossing each other is described wherein the set of wavy bars forms an ‘X’ structure when viewed from the front. The wavy bars are inclined to each other to split the flow into various sub-flows, parts of which are carried by the inclined surfaces. The wavy pattern helps in the creation of local turbulence and vortices.

### Description of Flow

The flow happens axially in the pipe. The flow gets split by the multitude of wavy cross bars. Each branch of the split stream encounters the neighbouring branch of the stream split by another cross bar. These two streams combine and then encounter another set of wavy cross bars and the stream is again split into two. All the split streams recombine after exiting the static mixer element.

### Description of the Exemplary Aspects of the Embodiment of the Invention Pertaining to the Apparatus Comprising Static Mixers Possessing Sinusoidal-Wavy Bars as Structural Elements

The exemplary aspects of the embodiment of the invention pertaining to the apparatus comprising of stacked plurality of static mixers wherein each individual static mixer possesses sinusoidal-wavy bars as structural elements as disclosed in FIG. 2 for the first time can be further illustrated in the following paragraphs drawing reference to FIGS. 6 to 8 in a detailed manner.

One aspect of the invention as depicted in FIG. 2 for the first time can be described drawing reference to FIG. 6. FIG. 6 gives the axial view of the static mixer. This is how the fluid appears when entering the static mixer element. In the top figure, the wavy cross elements can be seen. They form an ‘X’ shape vent as viewed from the front. They split the flow into multiple sub flows that impinge on each other and combine again to form a single flow at the end of the mixer element. The bottom figure shows the hidden edges as indicated by the dashed lines. As the mixer is symmetric, both of the axial views pertaining to those of the fluid entering and leaving the mixer are identical.

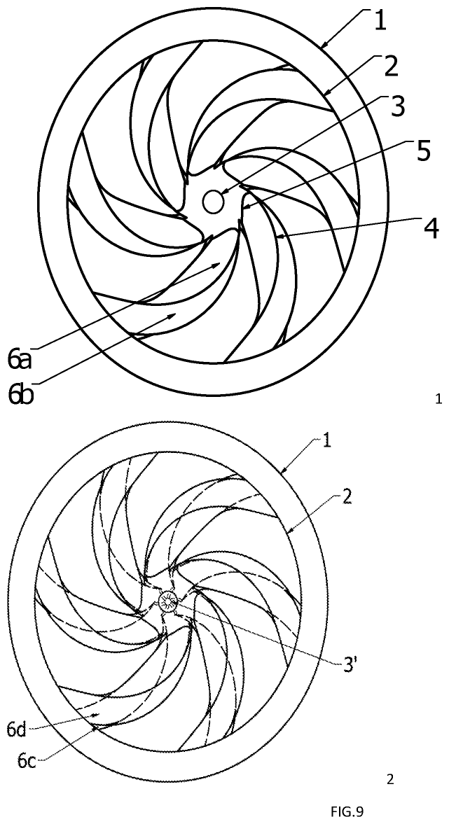

One aspect of the invention as depicted in FIG. 2 for the first time can be described drawing reference to FIG. 7. FIG. 7 shows the cut section of the static mixer along the diameter of the pipe. The cutting line is represented by line A-A. The figure below represents the cut section of the individual mixer. The hashed/shaded regions represent the cut solid section of the mixer element.

One exemplary aspect of the invention as depicted in FIG. 2 for the first time can be described drawing reference to FIG. 8. FIG. 8 shows the orthogonal projection of the static mixer elements alone. The Top View ‘T’ of the mixer (axial view) shows how the flow encounters the mixer. The side view ‘S’ just shows the wavy nature of the oblique elements. The front view ‘F’ shows the X profile the oblique elements make with each other.

Additional aspects of the embodiment of the invention as depicted in FIG. 2 for the first time pertaining to the apparatus comprising of stacked plurality of static mixers possessing sinusoidal-wavy bar structural elements, as disclosed by the instant invention are possible, by varying the key aspects of the sinusoidal-wavy bar structural element as disclosed herein: by making the pipe to be non-circular; by way of making the wavy bars/oblique elements to have at least 2 peaks and troughs across the diameter of the pipe; by changing the amplitude A of the wavy pattern, according to the equation, where 0.1×D≤A<1×D; And further, multiple static mixers can be stacked axially in a pipe, a slight rotation given to the mixers about the axis of the pipe thereby ensuring a through mixing the flow passing through the conduit comprising of the stacked individual static mixers possessing sinusoidal-wavy bar structural elements.

### Description of the Embodiment of the Invention as First Depicted in FIG. 3 Pertaining to the Apparatus Comprising Static Mixer Possessing Shuttle-Cock Structural Elements

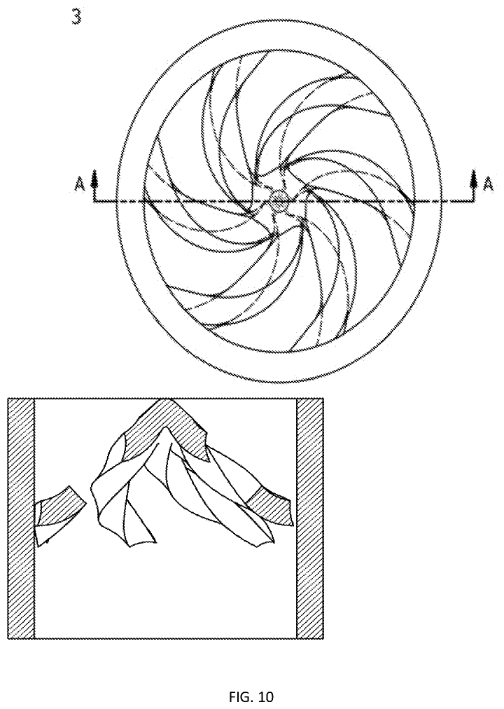

Drawing reference to FIG. 3, the specific embodiment shows the cross-sectional view of the apparatus comprising the stacked static mixers individually possessing shuttle-cock type structural element responsible for splitting and combining the flow wherein the assembly of stacked individual mixers and their arrangement in a conduit is depicted. Herein the splitting action is realized by way of the shuttle-cock type structure showing the alternating splitting and combining zones. The dimensions of the conduit on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 205 mm; Inlet nozzle shape is circular in cross-section. On the utility side, the parameters are: thickness is 2 mm; width is 38 mm; Inlet and outlet nozzle diameter is 10 mm; shape is rectangular; The 3D image of the Splitting and combining pattern for static mixing of fluids is clearly depicted herein. The splitting and combining pattern is repeated throughout the length of the process side. Here 201 represents the Metal Wall of the inside tube containing static mixers and the flow volume for process fluid, whereas 202 is the outer casing of the wall. 301 a & b represent the blow-up images of the flow path through the static mixer possessing shuttle-cock type structural elements. The unshaded area indicates the path for fluid flow. The important embodiment of the invention as depicted in FIG. 3 for the first time is further illustrated drawing reference to FIGS. 9-10 that illustrated the specific aspects of the invention as contained in FIG. 3 in a detailed manner in the following paragraphs.

### Description of Mixer

A monolithic static mixer for multi-phase flow consisting of multiple radially twisting bar elements meeting at a common point at the center of the pipe is described here. The radial twisted bar elements are responsible for disrupting the fluid flow and imparting radial as well as transverse velocities to the fluid. It also generates local vortices. Multiple static mixer elements can be stacked axially in a pipe with a slight rotation given to each of them with respect to the upstream static mixer to create a near opaque axial view of the pipe.

### Description of Flow

The fluid enters the static mixer along the axis of the pipe. The fluid stream encounters the tip of the static mixer. This tip rips the fluid streams in the very middle of the pipe and imparts a radially outward velocity to the flow. The flow is then cut by edge. This splits the flow into multiple radial elements. These radial elements resemble a pie wedge shape. Each pie wedge shape is imparted with rotation about transverse axis. The straight edges of the pie wedge shape will have formation of local vortices. The surfaces 1; 6a, 1; 6b, 1; 6c, and 1; 6d cause the flow to be split as well as general local vortices whose axis is tangential to the surfaces and perpendicular to the surface normals. All the split flows then recombine after the static mixers.

### Description of the Exemplary Aspects of the Embodiment of the Invention Pertaining to the Apparatus Comprising Static Mixers Possessing Shuttle Cock Structural Elements

The exemplary aspects of the embodiment of the invention pertaining to the apparatus comprising stacked plurality of static mixers possessing shuttle-cock structural elements as first depicted in FIG. 3 for the first time can be described in detail taking the guidance parameters as given below. The flow happens axially in the pipe. The hidden edges in a view are represented by dashed lines. The labelling and the description of the labelling is as given hereunder and remains the same though out the description whenever references are drawn towards the figures of identical nature.

| Label | Description |
|---|---|
| 1 | Outer Diameter (OD) of the pipe; circular in nature |
| 2 | Inner Diameter (ID) of the pipe; circular in nature |
| 3 | Top splitting tip of static mixer |
| 3′ | Bottom rotating vanes of the static mixer |
| 4 | Radial splitting edge of static mixer |
| 5 | Starting edge of the radially curved bar elements |
| 6a | Top surface of radially curved bar element |
| 6b | Top transverse surface of radially curved bar element |
| 6c | Bottom transverse surface of radially curved bar element |
| 6d | Bottom surface of radially curved bar element. |

One exemplary aspect of the embodiment of the invention as disclosed in FIG. 3 for the first time is further described drawing reference to FIG. 9 taking the guidance parameters as given above. FIG. 9 gives the axial view of the static mixer as illustrated in FIG. 3 for the first time. The illustration discloses how the flow gets split when it meets the static mixer. The top surfaces (1; 6a & 1; 6b) and cutting edges of the static mixer are clearly illustrated that give an idea of the distinctive features of invention as contained in FIG. 3.

Another aspect of the embodiment of the invention as disclosed in FIG. 3 for the first time is further described drawing reference to the features of the invention illustrated in FIG. 10: FIG. 10 gives the front cut section of the static mixer as illustrated in FIG. 3 for the first time. This figure illustrates the shape of the mixer possessing shuttle-cock structural element wherein the figure comprises of the view of the mixer cut across the diameter of the pipe as represented by the dashed line A-A. The bottom diagram shows the cut section.

Additional aspects of the embodiment of the invention pertaining to the apparatus comprising static mixers possessing shuttle cock structural element as depicted in FIG. 3 for the first time can be realized by varying the key aspects of the embodiment as given here, by making the pipe to be a non-circular pipe; the shuttlecock structural elements to attain non-radially symmetry by way of omitting some of the radially curving bar elements depending on the demands of the situation; making the radially curved bar elements to be radially straight; making the radially curved bar elements non-twisted; twisting the radially curved bar elements by an angle θ, where 0°≤θ≤180°; making some of the curved bar elements to not fully meet the ID of the pipe; vaying the number N of the radially curved bar elements where 2≤N≤15; using radially curved bar elements that deviate from the radius by an angle α, where 0°≤α≤90°; drilling holes and slots on the surfaces to accommodate various requirements of flow characteristics.

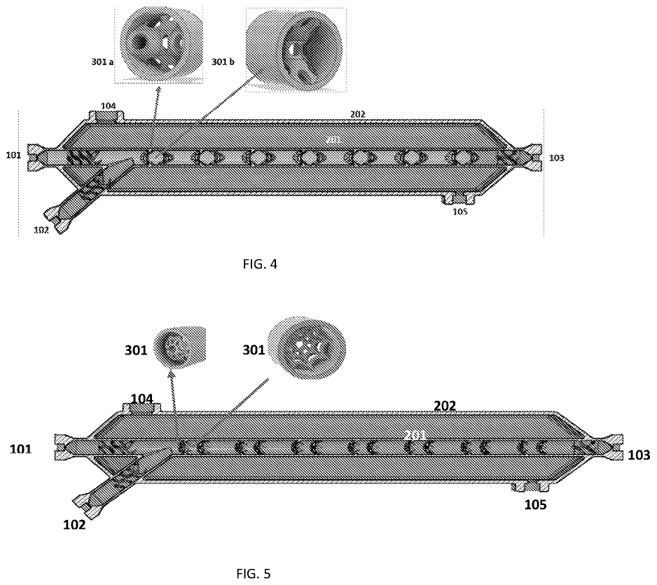

### Description of the Embodiment of the Invention as Depicted in FIG. 4 for the First Time with Individual Static-Mixers Possessing Slotted-Hyperbolic-Paraboloid as the Structural Element

Drawing reference to FIG. 4, the specific embodiment shows the cross-sectional view of the apparatus comprising the stacked static mixers individually possessing slotted-hyperbolic-paraboloid as the structural element responsible for splitting and combining the multiphasic flow, wherein the assembly of stacked individual static mixers and their arrangement in a conduit is depicted. Here the splitting action is realized by way of the structural elements in the form of a slotted hyperbolic paraboloid on the inner walls of the individual static mixers. The figure also depicts cross sectional view of the conduit having the stacked static mixers showing the alternating splitting and combining zones. The dimensions of the conduit on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 205 mm; Inlet nozzle shape is circular in cross-section. On the utility side, the parameters are: thickness is 2 mm; width is 38 mm; Inlet and outlet nozzle diameter is 10 mm; shape is rectangular; The 3D image of the Splitting and combining pattern for static mixing of fluids is clearly depicted herein. The splitting and combining pattern is repeated throughout the length of the process side. Here 201 represents the Metal Wall of the inside tube containing static mixers and the flow volume for process fluid, whereas 202 is the outer casing of the wall. 301 a & b represent the blow-up images of the flow path through the static mixer possessing slotted hyperbolic paraboloid structural elements. The unshaded area indicates the path for fluid flow. The important embodiment of the invention as depicted in FIG. 4 for the first time is further illustrated drawing reference to FIGS. 11 to 15 that describe the specific aspects of the embodiment illustrated in FIG. 4 for the first time in a detailed manner in the following paragraphs.

### Description of the Embodiment of the Invention Pertaining to the Apparatus Comprising of Static Mixers Possessing Slotted-Hyperbolic-Paraboloid Structural Element

### Description of the Mixer

A static mixer consisting of slotted-Hyperbolic-Paraboloid structural element to promote mixing of multi-phase flow components is described here. The inherent structure of the mixer leads to generation of multiple fluid regions having different velocities and this difference in velocities is responsible for better mixing. Slots and holes are cut into the surfaces which are either converging or diverging based on the topography of the surface. The converging and diverging nature of the slots/holes is dependent on the generalized areas wherein the slots/holes are placed or are configured. Between two consecutive mixers, the existing converging/diverging property of the slots/holes is reversible in identical locations which results in intensified mixing of the multiphasic flow.

Multiples of static mixers possessing slotted-Hyperbolic-Paraboloid structural elements can be stacked in a pipe with a slight rotation in the placement of the mixer in relation to the axis of the pipe.

### Description of Flow

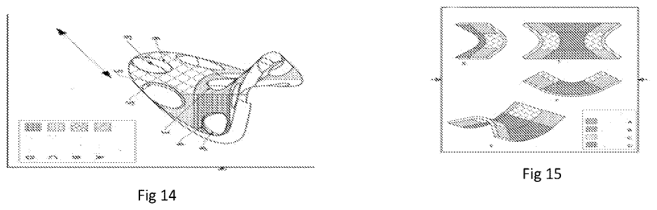

FIG. 11 shows the generalized structure of the slotted-hyperbolic-paraboloid structural element. This figure is used to show the different categorized surfaces. FIG. 14 shows the categorized surfaces on the actual static mixer itself. The fluid flows axially through the pipe. The flow through the pipe first hits Surface B. A converging hole is made here, and the fluid gets compressed through this hole. The converging hole imparts a velocity to the fluid that is radially outwards. The remaining fluid is diverted to Surface A and Surface C which surround Surface B. The hole in Surface A is converging in nature (FIG. 1a_3 and FIG. 1a_3′). The holes in Surface C retain their cross-section but impart a radially inwards velocity to the fluid passing through it. Rest of the fluid is then diverted to interact with Surface D. As Surface D is the last surface the fluid encounters, the final flow happens through this section. The holes in this region expand to larger holes. This causes the fluid to expand. These expanding holes impart a radially inwards velocity to the fluid. Various converging or diverging holes/slots can be cut on these categorized surfaces to achieve different mixing and heat transfer capabilities.

### Description of the Exemplary Aspects of the Embodiment of the Invention Pertaining to the Apparatus Comprising Static Mixers Possessing Slotted-Hyperbolic-Paraboloid Structural Elements

The exemplary aspects of the embodiment of the invention pertaining to the apparatus comprising static mixers possessing slotted-hyperbolic-paraboloid structural elements as depicted in FIG. 4 for the first time can be described by drawing reference to the aspects as illustrated in FIGS. 11-15 taking guidance parameters as given in table below. Top surface refers to the surface visible in FIG. 11. It is also labelled as 7.

| Label | Description |
|---|---|
| 1 | Outer Diameter (OD) of pipe, circular in nature |
| 2 | Inner Diameter (ID) of pipe, circular in nature |
| 3 | Middle circular hole on top Surface A |
| 3′ | Contracted Elliptical hole on bottom Surface A |
| 4 | Circular hole on top Surface D |
| 4′ | Expanded Elliptical hole on bottom Surface D |
| 5 | Circular hole on top Surface C |
| 5′ | Circular hole on bottom Surface C |
| 6 | Circular hole on top Surface B |
| 6′ | Contracted hole on bottom Surface B |
| 7 | Top surface. The first surface the fluid encounters. It |
| | encompasses surfaces A through D |
| 8 | Bottom surface. The exit surface the fluid encounters. |
| | It encompasses surfaces A through D |

One exemplary aspect of the invention as depicted in FIG. 4 for the first time can be described drawing reference to FIG. 11: Here 1a gives an axial view of the static mixer as the fluid enters the mixer element. This represents how the fluid gets split as it flows through the pipe. The top surface (FIG. 1a_7) can be seen in this view. All the holes can be seen here. 1b is an axial view of the static mixer as the fluid enters the mixer element. The top surface is visible here. The expansion and contraction of the cut holes can also be observed here. The dashed lines represent the hidden edges; these edges lie on the bottom surface and are indicative of how the holes on the top surface undergo transition.

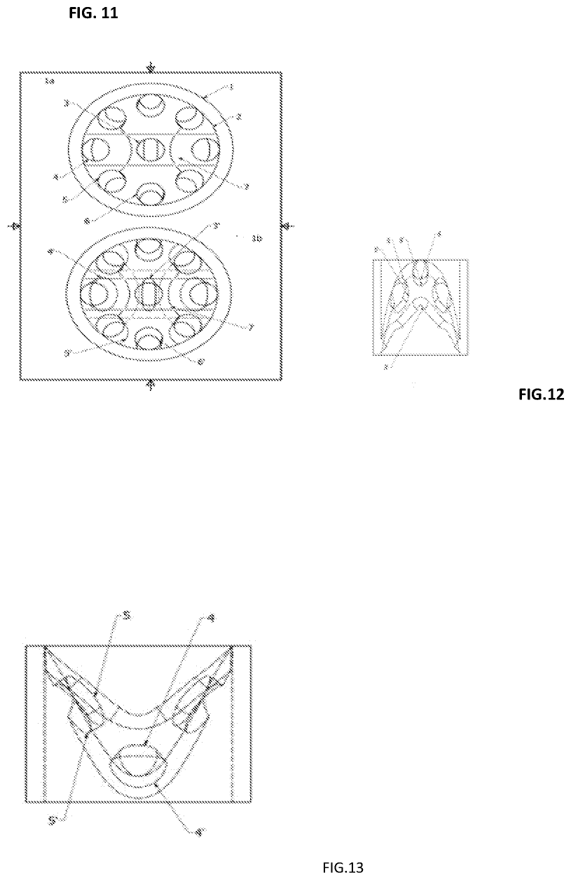

One aspect of the invention as depicted in FIG. 4 for the first time can be further illustrated drawing reference to FIG. 12: This shows the front view of the static mixer. Surface B and Surface C can be seen in this view. The corresponding holes 6-6′ and 5-5′ can also be observed.

One aspect of the invention as depicted in FIG. 4 for the first time can be further illustrated drawing reference to FIG. 13: This figure shows the right side view of the static mixer. This view is 90° rotation with respect to the axis of the pipe. Surface A and Surface D can be seen here. The corresponding holes 3-3′ and 4-4′ can also be seen.

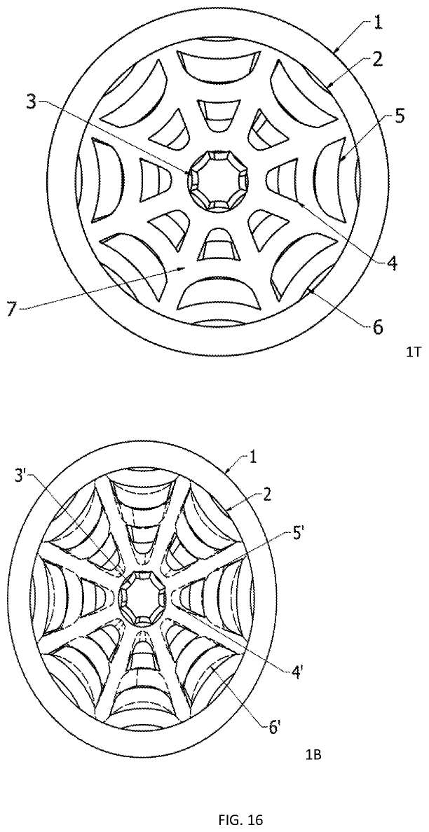

Another aspect of the invention as depicted in FIG. 4 for the first time can be further illustrated drawing reference to FIG. 14: This figure shows the categorized surfaces as seen in FIG. 15 when applied to the actual static mixer surface.

One more aspect of the invention as depicted in FIG. 4 for the first time can be further illustrated drawing reference to FIG. 15: This figure shows the generalized slotted-Hyperbolic-Paraboloid structural element and how it is split into 4 distinct surfaces. The categorization of these surfaces determines the type of hole/slot that will be cut into it, i.e., converging hole or diverging hole.

Additional aspects of the embodiment of the invention pertaining to the apparatus comprising of static mixers possessing slotted-hyperbolic-paraboloid structural element can be realized by way of varying the key aspects of the embodiment as depicted in FIG. 4 for the first time as given here: by way of using multiple radial and rectangular patterns for the holes; varying the size of the holes/slots; stacking of multiple static mixers in a pipe with the static mixers being rotated by an angle ϑ with respect to each other around the axis of the pipe, where 0°<ϑ≤90%; by cutting multiple parallel slots onto the surface; making use of porous media to make static mixer without any holes so as to use it as a Sparger; making multiple stacked porous Hyperbolic-paraboloid structural elements that can act as a Flame arrester.

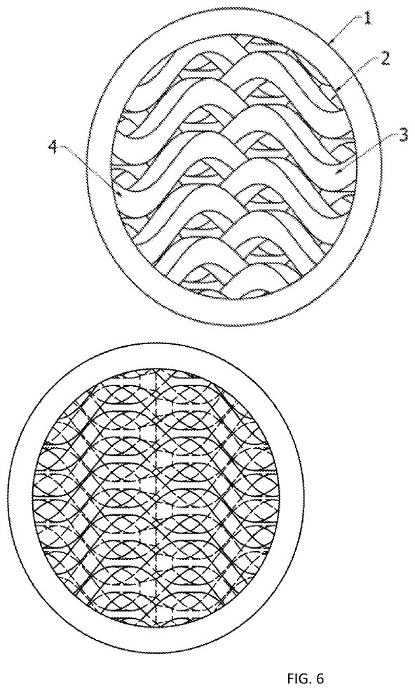

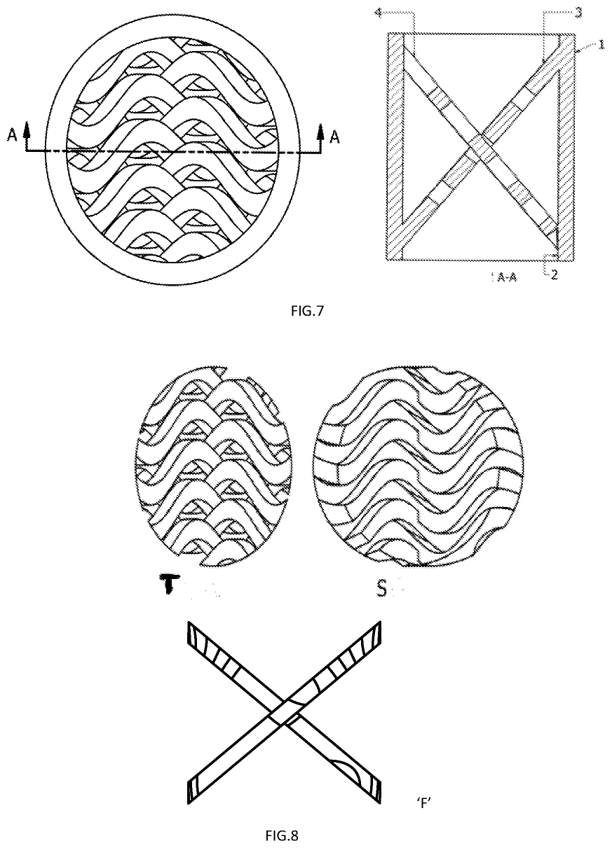

### Description of the Embodiment of the Invention as Depicted in FIG. 5 for the First Time Pertaining to the Apparatus Comprising of Static Mixers Possessing Slotted-Paraboloid Structural Element

Drawing reference to FIG. 5, the specific embodiment shows the cross-sectional view of the apparatus comprising the stacked static mixers possessing slotted paraboloid structures as the structural elements responsible for splitting and combining the multiphasic flow in the conduit, wherein the assembly of stacked individual mixers and their arrangement in a conduit is depicted. Here the splitting action is realized by way of the slotted paraboloid structures arranged on the inner walls of individual static mixers that have been stacked in the conduit and FIG. 5 further depicts the alternating splitting and combining zones in the conduit. The dimensions of the conduit on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 205 mm; Inlet nozzle shape is circular in cross-section. On the utility side, the parameters are: thickness is 2 mm; width is 38 mm; Inlet and outlet nozzle diameter is 10 mm; shape is rectangular; The 3D image of the Splitting and combining pattern for static mixing of fluids is clearly depicted herein. The splitting and combining pattern is repeated throughout the length of the process side. Here 201 represents the Metal Wall of the inside tube containing static mixers and the flow volume for process fluid, whereas 202 is the outer casing of the wall. 301 a & b represent the blow-up images of the flow path through the static mixers possessing slotted paraboloid structures arranged internally. The unshaded area indicates the path for fluid flow. The specific embodiment as illustrated in FIG. 5 for the first time is further illustrated drawing reference to FIGS. 16-18 that described the specific aspects of the embodiment as depicted in FIG. 5 in a detailed manner in the following paragraphs.

### Description of the Embodiment of the Invention Pertaining to the Apparatus Comprising of Static Mixers Possessing Slotted-Paraboloid Structural Element

### Description of the Mixer

A Paraboloid monolithic static mixer for multiphase flow consisting of a slotted-Paraboloid structural element with multiple slots cut into it to facilitate mixing. The cut slots direct the flow radially inwards. Multiple static mixers can be placed in each pipe with slight rotation of each static mixer with respect to the upstream mixer about the axis of the pipe.

### Description of Flow

The fluid/s flow along the axis of the pipe. This static mixer is inserted to disrupt the fully developed flow. The paraboloid bulge is opposite to the parabolic velocity profile that occurs in a fully developed flow. The middle of the pipe has the highest velocity (Free stream velocity). This stream of fluid is the first to encounter the static mixer. Part of the stream is forced to flow through the central slot. This slot becomes smaller along the axis of the pipe. This contracting slot causes the fluid to speed up slightly. The rest of the fluid streams are made to flow through the slots placed radially on the Paraboloid. The rest of the radial slots impart a radially inward velocity to the flow. These flow streams intersect with the middle flow stream. This creates high turbulence downstream of the mixer which promotes mixing within the radial layers. The increase in turbulence also promotes increase in heat transfer and the disruption of the boundary layer. The slots as shown in FIG. 16 are made such that:
Slot 3 is contracting in nature.
Slots 4, 5, and 6 are expanding in nature.
   This combination of expanding and contracting slots forces the flow radially inwards downstream of the mixer element.

### Description of the Exemplary Aspects of the Embodiment of the Invention Pertaining to the Apparatus Comprising Static Mixers Possessing Slotted-Paraboloid Structural Elements

The exemplary aspects of the embodiment of the invention pertaining to the apparatus comprising static mixers possessing slotted-paraboloid structural elements as depicted in FIG. 5 for the first time can be described by drawing reference to the aspects as illustrated in FIGS. 16-18 taking guidance parameters as labelled along with directives given in the table below. Dashed lines represent hidden edges that are not visible in the current view. Shaded/Hatched regions represent cut sections.

| Label | Description |
|---|---|
| 1 | Outer Diameter (OD) of the pipe; circular in nature |
| 2 | Inner Diameter (ID) of the pipe; circular in nature |
| 3 | Middle Octagonal slot (contracting) placed on top surface |
| 3′ | Middle Octagonal slot (contracting) placed on bottom surface |
| 4 | Radial slot (expanding) placed on top surface |
| 4′ | Radial slot (expanding) placed on bottom surface |
| 5 | Penultimate Radial slot (expanding) placed on top surface |
| 5′ | Penultimate Radial slot (expanding) placed on bottom surface |
| 6′ | Last Radial slot (expanding) placed on top surface |

One exemplary aspect of the embodiment of the invention pertaining to the apparatus comprising of static mixers possessing slotted-paraboloid structural element as depicted in FIG. 5 for the first time can be described drawing reference to FIG. 16: 1 (at the Top); gives the axial view of the static mixer. This gives the splitting of the fluid as soon it enters the mixer element. Slots 3, 4, 5, and 6 are observed in this view. The functions of these slots are explained in the description of flow. All the slots either expand or contract. These slots force the liquid towards the centre of the axis of the pipe. Figure at the Bottom gives the axial view of the static mixer. It shows the above figure with hidden lines being represented with dashed lines. These dashed lines indicate the slots' transition as they reach the bottom surface. These transitioned slots are labelled with an apostrophe “′”. Slots 3′, 4′, 5′, and 6′ correspond to Slots 3, 4, 5, and 6 on the top surface.

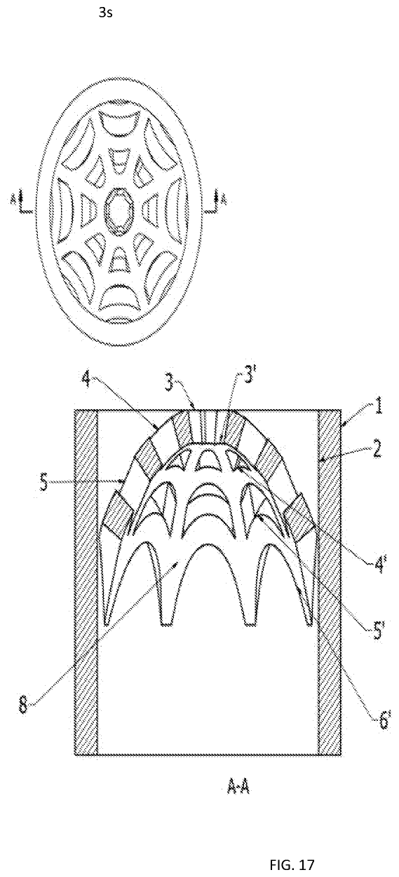

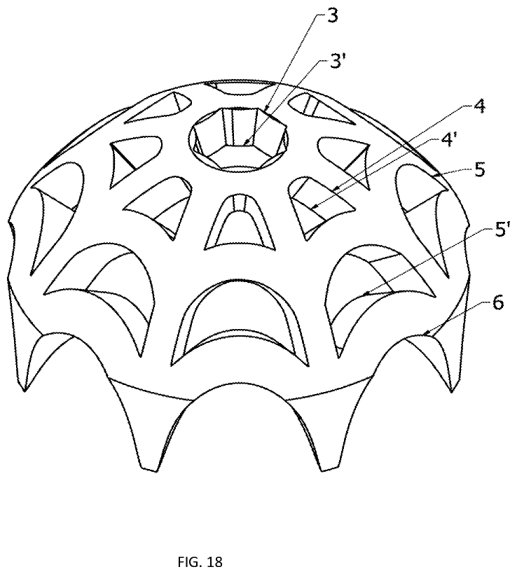

One aspect of the embodiment of the invention pertaining to the apparatus comprising of static mixers possessing slotted-paraboloid structural element as depicted in FIG. 5 for the first time can be described drawing reference to FIG. 17: Here 3s shows the cut section of the static mixer. The cutting line is represented by line A-A. we can see the cut section of the mixer and also the paraboloid shape of the mixer as given by A-A.

One aspect of the embodiment of the invention pertaining to the apparatus comprising of static mixers possessing slotted-paraboloid structural element as depicted in FIG. 5 for the first time can be described drawing reference to FIG. 18: This figure shows the static mixer without the outer pipe. This is indicative of the employability of the static mixer as an insert.

Additional aspects of the embodiment of the invention pertaining to the apparatus comprising of static mixers possessing slotted-paraboloid structural elements can be realized by varying the key aspects of the invention as given here: by way of making the pipe to be non-circular; making the slots to be either converging or diverging; varying the slot-cut from circular to any n sided polygon; varying shape of the slots to be straight so that they do not converge or diverge or force the liquid radially; and also ensuring that fully circular slots are cut with just enough support members.

Accordingly, the apparatus disclosed herein represent a significant improvement over prior art by providing apparatus that uniquely solve the problems of providing a superior mixing action in a multi-phasic flow ensuring enhanced mass-transfer, heat-transfer and improved mixing and dispersion of gas-liquid systems with minimal pressure head loss downstream of the injection site.

Those skilled in the art will appreciate that the conception, upon which this disclosure is based, may readily be utilized as a basis for designing other products without departing from the spirit and scope of the invention as defined by the appended claims. Therefore, the claims are not to be limited to the specific examples depicted herein. For example, the features of one example disclosed above can be used with the features of another example.

Furthermore, various modifications and rearrangements of the parts may be made without departing from the spirit and scope of the underlying inventive concept. For example, the geometric configurations disclosed herein may be altered depending upon the application, as may be the material selection for the components. Thus, the details of these components as set forth in the above-described examples, should not limit the scope of the claims.

The various embodiments of the invention of “Apparatus for Passive Mixing of Multiphase Flow through Splitting” are realized in the following examples.

The apparatus for enhancing the mixing efficiency of a multiphasic flow comprising a stacked plurality of static mixers that possessed specially configured structural elements to effect alternate splitting and combining of the multiphasic flow by way of the structural elements of sinusoidal wavy bars, shuttle-cock like structures, slotted hyperbolic paraboloid structures, slotted paraboloid structures on the inner walls of the individual static mixer that formed the stack of the plurality of static mixers in the conduit of the apparatus as described in the invention are produced as per the detailed description as disclosed by the instant invention and are tested to evaluate their mixing efficiency experimentally taking water-acetic acid-toluene system and the results are compared with those obtained from experiments conducted on similar lines in batch mode as well as in a tube reactor. The experimental results are given in the following paragraphs.

Mass transfer studies are conducted by the “Apparatus for passive mixing of multiphase flow through splitting” or Static mixer reactors (SMRs) as disclosed by the invention to assess and quantify the mixing capabilities of the apparatus or the reactors. Liquid-liquid extraction (LLE) is the physical method employed to ascertain the effective interphase mass transfer in a given system (reactor or mixed vessel or SMRs).

The liquid-liquid extraction of the ternary system of water-acetic acid-toluene, is studied in a batch system to obtain equilibrium concentration. The same extraction is performed using the apparatus contained in the instant invention to establish their mass transfer efficiency. Similar experiments were conducted in an empty tubular reactor (without the static mixers as disclosed by the instant invention) with a T-joint, to establish the base line mass transfer coefficients without the static mixers. Mass transfer coefficients are evaluated for the liquid-liquid-extraction of water-acetic acid-toluene in a flow system using the apparatus comprising the stacked static mixers with modified geometry as disclosed in the invention. The enhanced efficiency due to the stacked plurality of the static mixers possessing structural elements on their inner walls present inside the apparatus as contained in the instant invention is evaluated by comparing the experimental results.

### Example 1

### Batch Experiment to Establish the Equilibrium Between Toluene and Water Phase for Acetic Acid (Aa) Partition

Equal volumes (50 mL) of 30 w/w % Acetic Acid in water (feed, raffinate) and Toluene (extractant) are taken in a Round bottom flask. The mixture is kept for stirring at 950 rpm. Samples are collected for every fifteen minutes, and the mixture is transferred to separating funnel where the ternary system gets separated into two definite layers namely, top organic layer which is toluene dominant and the bottom aqueous layer that is water dominant. Acetic acid content in both the layers is analysed by titrating known amount of sample against 1 N NaOH. 15 ml of methanol and water are used as solvents for titrating the organic and aqueous layers respectively. The amount of NaOH consumed is used to determine Acetic acid % in both the layers by using equation 1

$$wt / wt \% Acetic Acid = \frac{\begin{matrix}{N}_{NaOH} \times Vol of NaOH consumed \times \\ Molecular Weight of Acetic Acid\end{matrix}}{10 \times Weight of sample taken} \qquad eqn . 1$$

Burette reading gives the value for the Vol of NaOH consumed in mL. Samples are collected until repetitive burette readings occur. Content of acetic acid taken as normality is used to calculate Partition coefficient (KD) and Mass transfer coefficient (K_{L}a) which is given by equation 2 and 3 respectively.

$${K}_{D} = \frac{[ {AA}_{org} ]}{[ {AA}_{aq} ]} \qquad eqn . 2$$

Where, [AA_{org}] is the concentration of acetic acid in organic phase and [AA_{aq}] implies concentration of acetic acid in aqueous phase. Using the equilibrium concentration and the initial concentration of the solute AA in both the phases the mass transfer coefficient for an interphase mass transfer is calculated according to the equation 3. This will be used in subsequent sections for SMRs.

$${K}_{L} a = \frac{1}{τ} ln ( \frac{{C}_{in} - {C}^{*}}{{C}_{out} - {C}^{*}} ) {min}^{- 1} \qquad eqn . 3$$

Where Cᵢₙ, Cₒᵤₜ are the concentrations of the solute in inlet, outlet of the reactor at time τ and C* is the equilibrium concentration. The data obtained from batch studies is summarised in table1. From table1, it can be observed that between 75 to 150 min, the concentration of AA in organic phase remained constant which indicated the attainment of the equilibrium between the two layers. The average concentration of AA in Organic (toluene) phase is taken as the equilibrium concentration and it is found to be 0.634 N. This is used as C* in the equation 3 to calculate mass transfer coefficient for all the subsequent calculations for the apparatus comprising static mixer reactors (SMRs).

TABLE 1
Batch study data
Concentration of AA in toluene layer as
function of time of contact in a batch system

| Time | wt % AA | [AA], Normality |
|---|---|---|
| 0 | 0.000 | 0.000 |
| 15 | 2.227 | 0.371 |
| 30 | 1.565 | 0.391 |
| 45 | 3.056 | 0.509 |
| 60 | 3.571 | 0.595 |
| 75 | 3.881 | 0.646 |
| 90 | 3.750 | 0.625 |
| 105 | 3.870 | 0.644 |
| 120 | 3.853 | 0.642 |
| 135 | 3.781 | 0.630 |
| 150 | 3.709 | 0.618 |

| | |
|---|---|
| Equilibrium concentration of | 0.634N |
| AA in Toluene organic layer | |

### Example 2

Studies Conducted with the Apparatus Containing Stacked Plurality of Static-Mixers Possessing Structural Elements of Sinusoidal Wavy Bars, Shuttle-Cock Like Structures, Slotted-Hyperbolic-Paraboloid Structures, Slotted-Paraboloid Structures in a Housing [Static Mixer Reactors (SMRS)], and a Tube Reactor with T-Joint

### Experimental Setup

Liquid-liquid extraction procedure was carried out in SMRs to determine mass transfer coefficient by physical method. Two pumps, a separating funnel, and the SMR constituted the experimental setup. Calibrated metering pumps were used to pump known and desired flow of both the solvent and the feed solution. They enter the SMR, get mixed due to the static mixers (SMs) in the reactor and exchange takes place between immiscible organic and aqueous phases. The outlet of the SMR is connected to a separating funnel, where both phases collect and separate immediately, thereby stopping further exchange of mass between the phases. Each sample that was taken was immediately separated, and the solute content of both the layers was determined. This experiment was carried out at six different residence times: 0.25, 0.5, 1, 1.5, 2, 2.5 minutes, by varying the flow rates of the two liquids. The ratio of flow rates of both phases was maintained constant at all time intervals.

### Experimental Procedure

The feed solution (30% Acetic Acid in water) and solvent (Toluene) are pumped into the SMRs. Here they flow concurrently getting intimately mixed due the presence of the novel SMs and resulting in the mass transfer of acetic acid between the two phases. The flowrates of the pumps are fixed according to residence time, which is given by equation 4.

$$Flowrate = \frac{Volume of reactor}{Residence time} \frac{mL}{min} \qquad eqn . 4$$

The collected mixture is left for separation into aqueous and organic layers. Both the layers are analysed for Acetic Acid content by taking 5 gm of sample and titrating it against 1 N NaOH as discussed above. Equilibrium concentration is found by conducting batch studies. Mass transfer coefficient is calculated at each time of residence (t) using equation 3.

The experimental results and the mass transfer coefficients obtained, for the empty tube reactor, SMRs possessing sinusoidal wavy cross bars, shuttle-cock type structures, slotted-hyperbolic-paraboloid structures, and slotted-paraboloid structures as the structural elements are given below in tables 2 & 3 respectively.

TABLE 2
Estimation of mass transfer coefficients for empty tube with a T-Joint (baseline “flow” reactor)

| | organic layer | | | | | aqueous layer | | | | | | |
|---|---|---|---|---|---|---|---|---|---|---|---|---|
| | | 1.0N | | | | | 1.0N | | | | | Mass |
| | wt of | NaOH | | wt % | Concetration | wt of | NaOH | | | Concetration | | transfer |
| Residence | sample | titre | Calculated | AA | [AA org] | sample | titre | Calculated | % AA | [AA aq] | Partition | coefficient |
| time (min) | (gm) | value, ml | wt % AA | avg | (N) | (gm) | value, ml | wt % AA | avg | (N) | coefficient | min \hat{ }(−1) |
| 0.25 | 5.03 | 1.5 | 1.84 | 1.79 | 0.30 | 5 | 22.5 | 27.8 | 27.84 | 4.636 | 0.064 | 2.501 |
| | 5.01 | 1.4 | 1.73 | | | 5.02 | 22.6 | 27.8 | | | | |
| 0.5 | 5.05 | 1.7 | 2.08 | 2.03 | 0.34 | 5.03 | 22.3 | 27.4 | 27.57 | 4.590 | 0.074 | 1.501 |
| | 5.01 | 1.6 | 1.98 | | | 5 | 22.4 | 27.7 | | | | |
| 1 | 5.05 | 1.9 | 2.33 | 2.27 | 0.38 | 5.03 | 22 | 27.1 | 27.17 | 4.524 | 0.084 | 0.896 |
| | 5.01 | 1.8 | 2.22 | | | 5.01 | 22.1 | 27.3 | | | | |
| 1.5 | 5.02 | 1.9 | 2.34 | 2.40 | 0.40 | 5 | 21.9 | 27.1 | 27.04 | 4.504 | 0.089 | 0.653 |
| | 5.03 | 2 | 2.46 | | | 5.04 | 22 | 27.0 | | | | |
| 2 | 5.01 | 2.1 | 2.59 | 2.59 | 0.43 | 5.02 | 21.8 | 26.9 | 26.91 | 4.482 | 0.096 | 0.561 |
| | 5.01 | 2.1 | 2.59 | | | 5 | 21.8 | 27.0 | | | | |
| 2.5 | 5.06 | 2.2 | 2.69 | 2.64 | 0.44 | 5.02 | 21.7 | 26.7 | 26.74 | 4.454 | 0.099 | 0.464 |
| | 5.02 | 2.1 | 2.59 | | | 5.04 | 21.8 | 26.8 | | | | |

The first column is the residence time set for the articular run. This is for combined flow rates of the liquids and the tube volume is 40 ml. The next 5 columns show the estimation of the concentration of AA in organic layer estimated by titrating the isolated layer with 1 N NaOH. Subsequent 5 columns under the Aqueous layer indicate the same estimation for aqueous layer. The column partition coefficient is derived from the equation 2 and the mass transfer concentration is estimated based on equation 3. Equilibrium concentration of AA in organic layer is 0.64 N estimated earlier from the batch extraction experiments.

It is to be noted that for a fixed volume of reactor (here a tube), higher the residence time means lower the flow rates. Lower flow rate means less velocity of the liquids through the reactor. It is established in the science that higher the flow rate, better is the mixing and hence the mass transfer coefficient (m.t.c). The trend of m.t.c with residence time seen in the first and last columns of the above table indicate the same trend. Higher residence time, lower the flow rates, slower the velocity therefore lower the mass transfer coefficient. The trend asymptotically reaches a limit, which can be seen from the above data.

TABLE 3
M.T.C data obtained for the SMRs comprising of stacked plurality of static mixers
possessing wherein the individual static mixers are possessing structural elements
of sinusoidal wavy cross bars, shuttle-cock type structures, slotted hyperbolic
paraboloid structures, and slotted paraboloid structural elements individually
using ternary LLE system comprising of water- acetic acid-toluene system.

| Slotted- | | | | | | | |
|---|---|---|---|---|---|---|---|
| Hyperbolic- | | Slotted- | | Sinusoidal- | | Shuttle-cock | |
| Paraboloid | m.t.c (min | Paraboloid | m.t.c (min | Wavy bars | m.t.c (min | | m.t.c (min |
| Time, min | (−1)) | Time, min | (−1)) | Time, min | (−1)) | Time, min | (−1)) |
| 0.25 | 3.84 | 0.25 | 3.06 | 0.25 | 3.82 | 0.25 | 3.21 |
| 0.5 | 1.91 | 0.5 | 1.67 | 0.5 | 2.17 | 0.5 | 1.67 |
| 1 | 1.00 | 1 | 1.00 | 1 | 1.25 | 1 | 1.05 |
| 1.5 | 0.73 | 1.5 | 0.70 | 1.5 | 0.91 | 1.5 | 0.70 |
| 2 | 0.60 | 2 | 0.55 | 2 | 0.71 | 2 | 0.62 |
| 2.5 | 0.57 | 2.5 | 0.48 | 2.5 | 0.59 | 2.5 | 0.50 |

From tables 2 & 3, it can be concluded that continuous systems with novel split and combine SMRs show higher mass transfer coefficient compared to empty Tubular reactor due to the presence of static mixers possessing structural elements that could enhance the mixing efficiency and in turn mass transfer between the different phases of a multiphasic system. This establishes the utility of the apparatus disclosed in the invention for interphase mass transfer devices.

### Advantages of the Invention

The apparatus as disclosed by the instant invention for enhancing mixing efficiency of multi-phasic passive flow herein has the following advantages,
1. A significant improvement over prior art by providing an apparatus comprising a stacked plurality of static mixers that uniquely solves the problems of providing a superior mixing action in a multi-phasic flow
2. The apparatus disclosed herein ensures enhanced mass transfer, heat-transfer and improved mixing and dispersion of gas liquid systems with minimal pressure head loss downstream of the injection site.
3. The apparatus disclosed herein operates by splitting and combining the multiphasic flow due to the presence of structural elements present on the inner walls of the individual static mixers that can be stacked in a conduit axially offering a thorough mixing in multi-phasic systems and can be employed in additive manufacturing, process industries, as is exemplified from the experimental results obtained in the liquid-liquid-extraction studies done with water-acetic acid-toluene system wherein the invention provided better mass-transfer coefficient compared to the same done in a static mixer devoid of such geometrical modifications.
4. One important embodiment of the invention stresses on the importance of the structural elements that could split the multiphasic flow into various streams and allowing them to get combined thereby ensuring a thorough mixing of the elements of the multiphasic flow which is very essential to obtain products with high purity and in higher amounts especially when there is a considerable difference in the densities of the individual phases of the multiphasic system.
5. The heat transfer and the mass transfer between the liquid and gaseous phases of the multiphasic fluid is enhanced due to the thorough mixing ensured by the structural elements present in the individual static mixers and this aspect of the invention makes the invention suitable for application in pharmaceutical industries.

### Analysis of Novelty, Inventiveness and Utility

The instant invention of “APPARATUS FOR PASSIVE MIXING OF MULTI-PHASE FLOW THROUGH SPLITTING” is novel in the light of the prior art as it provides an apparatus or reactor comprising a stacked plurality of static mixers possessing structural elements or mixing elements on their inner walls, that considerably enhanced the mixing of a multiphasic-flow as is evident from the mass-transfer coefficients obtained from the liquid-liquid extraction studies done using water-acetic acid-toluene system. The inventiveness of the instant invention lies in arriving at the apparatus and a method to enhance the mixing efficiency in multi-phasic flow systems by way of introducing structural elements of sinusoidal wavy cross bars, shuttle-cock type structures, slotted hyperbolic paraboloid structures, and slotted paraboloid structural elements as structural elements on the inner walls of the individual static mixers that can be stacked in a conduit, which can be employed successfully in processes to obtain better yields. The various structural elements of the static mixers as illustrated in the various embodiments of the instant invention are indicative of the inventiveness of the instant invention. The utility aspect of the instant invention is realized as the instant invention discloses an apparatus that can provide enhanced mixing efficiency in multi-phase flows and which can be successfully employed in chemical process industries for speciality chemicals, pharmaceutical intermediates and API production, polymer production wherein a thorough mixing of the different phases has a profound effect on the yield and purity of the final product.

What is claimed:

1. An apparatus for the passive mixing of a multi-phase (ic) flow or hydrodynamic performance comprising a housing, having a conduit/tube or a channel extending internally from the fluid inlet to the outlet ports that comprises of stacked plurality of static-mixers possessing structural elements or mixing elements on the inner walls of the individual static mixers, that are responsible for splitting the multiphasic flow in to a number of streams and forcible recombination of the streams of the multiphasic flow through the conduit, bringing about the splitting-combining effect on the flow wherein,
a) the structural elements or mixing elements are selected from a group comprising of sinusoidal—wavy-bar like structural elements, shuttle-cock like structural elements, slotted-hyperbolic-paraboloid like structural elements, slotted-paraboloid-structural elements which are present on the inner walls of individual static mixers and are responsible for splitting and combining of the flow, resulting in an enhanced mixing of the multi-phasic flow,
b) The conduit comprises of a stacked plurality of, static-mixers possessing structural elements, across the length of the conduit that can allow the fluid to pass through them continuously experiencing splitting and combining, resulting in enhanced mixing, mass-transfer, and heat transfer,
c) The stacking of the individual static-mixers is responsible for forced recombination of the split streams of multiphasic flow at regular intervals,
d) The multiphasic flow experiences a cumulative splitting—combining effect resulting in an enhanced overall mixing efficiency due to plurality of static-mixers that are placed axially along the length of the conduit.

2. The apparatus as claimed in claim 1 comprising of stacked plurality of static mixers wherein, each individual static mixer of the stack is possessing sinusoidal-wavy-bars as the structural element or mixing element wherein,
a) multiple wavy bar elements are crisscrossing each other wherein the set of wavy bars forms an ‘X’ structure when viewed from the front,
b) The wavy bars are inclined to each other to split the flow into various sub-flows, parts of which are carried by the inclined surfaces,
c) The wavy pattern helps in the creation of local turbulence and vortices.

3. The enhanced mixing as claimed in claim 1 when the apparatus comprises of stacked plurality of static mixers possessing sinusoidal-wavy bars as the structural element can be further enhanced by varying,
a) The shape of the pipe to be non-circular,
b) The wavy bars to possess at least 2 peaks and troughs across the diameter of the pipe,
c) The amplitude A of the wavy pattern, wherein, 0.1×D≤A<1×D,

4. The apparatus as claimed in claim 1 comprising of stacked plurality of static mixers wherein, each individual static mixer of the stack is possessing shuttle-cock structural element or mixing element wherein,
a) multiple radially twisting bar elements are meeting at a common point at the centre of the pipe,
b) The radially twisted bar elements are responsible for disrupting the fluid flow by imparting radial as well as transverse velocities to the fluid,
c) the structural element generates local vortices,
d) Multiple static mixer elements that are stacked axially in a pipe with a slight rotation given to each of them with respect to the upstream static mixer creates a near opaque axial view of the pipe.

5. The enhanced mixing as claimed in claim 1 when the apparatus comprises of stacked plurality of static mixers possessing shuttle-cock structural element can be further enhanced by varying,
a) the shape of the pipe to be non-circular,
b) curved bars to be straightened,
c) the angle of twist θ of the radially curved bar elements where in, 0°≤θ≤180°,
d) position of some of the curved bar elements so as to not fully meet the inside of the pipe,
e) number N of radially curved bar elements wherein, 2≤N≤15,
f) The radially curved bar elements to deviate from the radius by an angle α, where 0°≤α≤90°,
g) surface to possess holes or slots.

6. The apparatus as claimed in claim 1 comprising of stacked plurality of static mixers wherein each individual static mixer of the stack is possessing slotted-hyperbolic-paraboloid structural element or mixing element wherein,
a) Slots and holes are cut into the surfaces which are either converging or diverging based on the topography of the surface,
b) The converging and diverging nature of the slots/holes is dependent on the generalized areas wherein the slots/holes are placed or are configured,
c) Between two consecutive mixers, the existing converging/diverging property of the slots/holes is reversible in identical locations.

7. The enhanced mixing as claimed in claim 1 when the apparatus comprises of stacked plurality of static mixers possessing slotted-hyperbolic-paraboloid structural elements can be further enhanced by varying,
a) shape of the slot,
b) size of the slot,
c) number of slots present on each structural element,
d) angle of rotation ϑ of the static mixers with respect to each other around the axis of the pipe, where 0°<ϑ≤90°;
e) nature of the surface of the structural element to have multiple parallel slots.

8. The apparatus as claimed in claim 1 comprising of stacked plurality of static mixers wherein each individual static mixer of the stack is possessing slotted-paraboloid structural element or mixing element wherein,
a) multiple slots are cut into the paraboloid structural element that are responsible for splitting the multiphasic flow into different streams,
b) The cut slots direct the flow radially inwards,

9. The enhanced mixing as claimed in claim 1 when the apparatus comprises of stacked plurality of static mixers possessing slotted-paraboloid structural element can be further enhanced by varying,
a) shape of the pipe to be non-circular,
b) The slots to be converging or diverging,
c) The shape of the slots to be circular or any n sided polygon,
d) cut of the slots to be straight such that they neither converge nor diverge or force the liquid radially,
e) cut of the slots to result in fully circular slots with just enough support.

10. The multiphase (ic) flow as claimed claim 1 selected from a group comprising of liquid-liquid, liquid-gas, liquid-liquid-gas, immiscible solvent systems, highly viscous liquids, liquid-solid, ternary systems, solvent-extraction-systems.

11. The apparatus as claimed in claim 1 for enhanced mixing of a multi-phasic flow that ensures enhanced mass-transfer, heat-transfer and improved dispersion in case of gas-liquid systems with minimal pressure head loss downstream of the injection site.
